(19) United States
(12) Patent Application Publication
(10) Pub. No.: US 2011/0068299 A1
(43) Pub. Date: Mar. 24, 2011

(54) METHOD OF FABRICATING NANO COMPOSITE POWDER CONSISTING OF CARBON NANOTUBE AND METAL

(75) Inventors: Soon-Hyung Hong, Daejeon (KR); Dong-Hoon Nam, Daejeon (KR); Sang Hak Kim, Seongnam (KR); Ki Chun Lee, Seoul (KR); Yoon-Kyoung Kim, Daejeon (KR)

(73) Assignees: Hyundai Motor Company, Seoul (KR); Kia Motors Corporation, Seoul (KR); KAIST, Daejeon (KR)

(21) Appl. No.: 12/796,008

(22) Filed: Jun. 8, 2010

(30) Foreign Application Priority Data
Sep. 24, 2009 (KR) 10-2009-0090574

(51) Int. Cl. C09K 3/00

(52) U.S. Cl. 252/182.33; 252/182.32; 252/182.35; 977/742; 977/842

(57) ABSTRACT

The present invention features in preferred aspects a method of fabricating nano composite powder consisting of carbon nanotubes and metal matrix powder is disclosed. The method includes a low-speed milling process of milling and mixing the carbon nanotubes and the metal matrix powder, and a high-speed milling process of milling the carbon nanotubes and the metal matrix powder which are homogenously mixed in the low-speed milling process to homogenously disperse the carbon nanotubes in the metal matrix powder. In certain preferred aspects, the method can prevent damage of the carbon nanotube and can homogenously disperse the carbon nanotubes in the metal matrix.

### CROSS-REFERENCE TO RELATED APPLICATION

This application is based on and claims under 35 U.S.C. §119(a) priority from Korean Patent Application No. 10-2009-90574, filed on Sep. 24, 2009 in the Korean Intellectual Property Office, the disclosure of which is incorporated herein in its entirety by reference.

### BACKGROUND OF THE INVENTION

1. Field of the invention

The present invention relates, generally, to a method of is fabricating nano composite powder consisting of carbon nanotubes and metal, and more particularly, to a method of fabricating nano composite powder that can prevent damage of the carbon nanotubes in a high energy milling process and can homogenously disperse the carbon nanotube in metal matrix.

2. Background Art

In general, a carbon nanotube is a material having superior mechanical, thermal, chemical and quantum properties. A carbon nanotube is typically used together with another material, such as a matrix material or substrate so that it can be utilized inhigh performance and high function material fields.

However, it can be difficult for the carbon nanotube to be homogeneously dispersed or arranged in the matrix material, and because of strong coherence which is caused by Van der Waals force. A problem remains in that the interface strength between the carbon nanotube and the metal matrix is deteriorated by the coherence.

Interest has been focused on a nano composite material consisting of the carbon nanotube and the metal. Presently, a carbon nanotube is fabricated by a process such as a powder mixing process, an impregnation process, a casting process, a ball milling process, or a high energy milling process.

In fabrication methods that have been described in the art, the carbon nanotube and ceramic or metal powder are subjected to a ball milling process, and then are sintered by discharging plasma to fabricate a composite material. The nano composite powder consisting of the carbon nanotube and the metal which is subjected to the ball milling process is cohered on the surface of the metal powder, because of the coherence of the carbon nanotube and the relative size between the carbon nanotube and the metal matrix material.

Accordingly, where the carbon nanotube and the metal powder are sintered to fabricate the nano composite powder consisting of the carbon nanotube and the metal, sinterability of the powder is suitably deteriorated, so that the density of the nano composite powder consisting of the carbon nanotube and the metal is lowered. The carbon nanotube is cohered on the crystal grain of the metal, and thus the mechanical property is suitably deteriorated.

Accordingly, a molecular level mixing process is disclosed in Korean Patent Publication No. 10-0558966, incorporated by reference in its entirety herein.

As described in the 10-0558966 publication, the molecular level mixing process fabricates a nano composite powder consisting of carbon nanotube and metal, of which the carbon nanotubes are homogeneously dispersed in a metal matrix.

However, since the above molecular level mixing process needs a process of reducing the nano composite powder consisting of the carbon nanotube and the metal, it is difficult to apply the process to metal which is hard to reduce, such as aluminum or titanium.

Accordingly, the molecular level mixing process further includes a high energy milling process to fabricate composite powder consisting of a metal matrix, such as aluminum, titanium, or magnesium, and the carbon nanotube.

Accordingly, the high energy milling process has an advantage in which the carbon nanotubes are dispersed in the metal powder, as well as the surface of the metal powder.

In the high energy milling process, however, high energy has to be introduced for a long time to homogeneously disperse the carbon nanotubes in the metal matrix. As a result, the carbon nanotube is broken or crystalline and is damaged by generation of the amorphous carbon.

For example, as shown in the graph in FIG. 1, if the high energy milling process is performed, the carbon nanotube is broken. Further, as shown in the photograph in FIG. 2, which shows the carbon nanotube viewed by electron microscopy, the carbon nanotube is considerably decreased.

Further, in the high energy milling process the thermal stability of the carbon nanotube is deteriorated and the carbon nanotube is reacted with the metal matrix to form a carbide, at the fabrication of the nano composite material consisting of carbon nanotube and metal by sintering the nano composite powder consisting of carbon nanotube and metal.

Accordingly, there is a need in the art for methods of fabricating nanocomposite powders consisting of carbon nanotubes and metal matrix.

The above information disclosed in this the Background section is only for enhancement of understanding of the background of the invention and therefore it may contain information that does not form the prior art that is already known in this country to a person of ordinary skill in the art.

### SUMMARY OF THE INVENTION

The present invention features, in preferred aspects, a method of fabricating nano composite powder consisting of carbon nanotube and metal. The present invention, preferably, can suitably prevent damage of the carbon nanotube in a high energy milling process and can homogenously disperse the carbon nanotubes in metal matrix.

In a preferred embodiment of the present invention, there is provided a method of fabricating nano composite powder consisting of carbon nanotubes and metal matrix powder, which preferably includes the steps of a low-speed milling process of milling and mixing the carbon nanotubes and the metal matrix powder; and a high-speed milling process of milling the carbon nanotubes and the metal matrix powder which are homogenously mixed in the low-speed milling process to homogenously disperse the carbon nanotubes in the metal matrix powder.

In certain preferred embodiments, the low-speed milling process is performed at a milling speed of 1 rpm to 100 rpm during 20 hours.

In other preferred embodiments, the high-speed milling process is performed at a milling speed of 100 rpm to 5000 rpm during 1 hour.

In one preferred embodiment, in the low-speed milling process and the high-speed milling process, any one milling machine of a planetary ball mill, a tumbler ball mill, and an attritor, and the planetary ball mill is used.

Preferably, the metal matrix powder includes at least one of aluminum, lithium, beryllium, magnesium, scandium, titanium, vanadium, chrome, manganese, iron, cobalt, nickel, copper, zinc, gallium, germanium, yttrium, zirconium, niobium, molybdenum, ruthenium, rhodium, palladium, silver, cadmium, indium, tin, stibium, tungsten, platinum, gold and lead.

In one exemplary embodiment, the carbon nanotube includes an aggregate of 5 to 40 nm in diameter and 1 μm to 5 μm in length.

In another exemplary embodiment, the carbon nanotube is dispersed in the metal matrix powder in a weight ratio of 0.1% to 50%.

Preferably, a weight ratio of weight of the carbon nanotubes and the aluminum powder and weight of a ball used in the milling machine and is set to be 1:1 to 1:50.

In another further preferred embodiment, since the carbon nanotube and the metal matrix powder are milled at low speed and then milled at high speed to fabricate nano composibe powder, it can prevent damage of the carbon nanotube and can homogenously disperse the carbon nanotubes in the metal matrix.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum).

As referred to herein, a hybrid vehicle is a vehicle that has two or more sources of power, for example both gasoline-powered and electric-powered.

The above features and advantages of the present invention will be apparent from or are set forth in more detail in the accompanying drawings, which are incorporated in and form a part of this specification, and the following Detailed Description, which together serve to explain by way of example the principles of the present invention.

### BRIEF DESCRIPTION OF THE DRAWINGS

The above and other objects, features and advantages of the present invention will be more apparent from the following detailed description taken in conjunction with the accompanying drawings, in which:

FIG. 1 is a graph illustrating a damage of carbon nanotubes fabricated by a method of a related art;

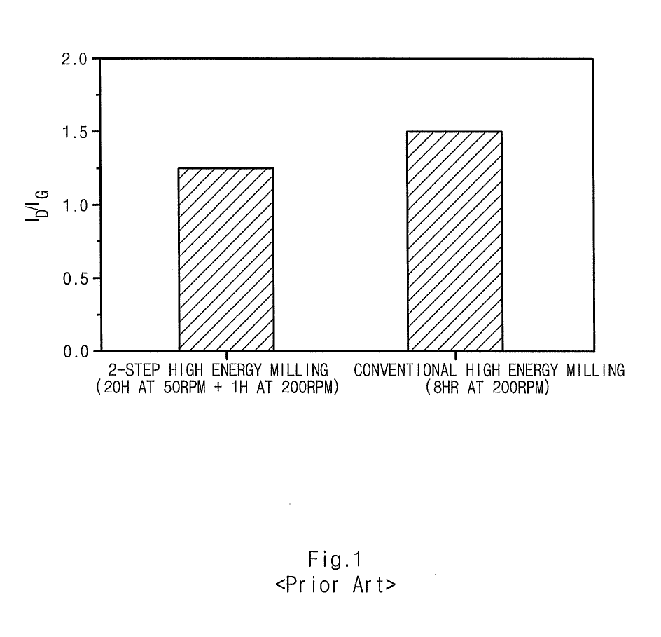

FIG. 2 is a microscope photograph of a carbon nanotube crystal fabricated by a method of a related art;

FIG. 3 is a flowchart illustrating a method of fabricating nano composite powder consisting of carbon nanotubes and metal according to an embodiment of the present invention;

FIG. 4 is a view illustrating a low-speed milling process according to an embodiment of the present invention;

FIG. 5 is a microscope photograph illustrating a mixture consisting of carbon nanotubes and metal matrix powder after a low-speed milling process according to an embodiment of the present invention;

FIG. 6 is a view illustrating a high-speed milling process according to an embodiment of the present invention;

FIG. 7 is a microscope photograph illustrating a mixture consisting of carbon nanotubes and metal matrix powder after a high-speed milling process according to an embodiment of the present invention; and

FIG. 8 is a graph illustrating a damage of carbon nanotubes fabricated by a method according to an embodiment of the present invention.

### DETAILED DESCRIPTION OF THE PREFERRED EMBODIMENTS

In a first aspect, the present invention features a method of fabricating a nano composite powder comprising a low-speed milling process of milling and mixing carbon nanotubes and metal matrix powder, and a high-speed milling process.

In one embodiment, the high-speed milling process comprises milling the carbon nanotubes and the metal matrix powder which are homogenously mixed in the low-speed milling process to homogenously disperse the carbon nanotubes in the metal matrix powder.

Hereinafter, preferred embodiments of the present invention will be described in detail with reference to the accompanying drawings. The aspects and features of the present invention and methods for achieving the aspects and features will be apparent by referring to the embodiments to be described in detail with reference to the accompanying drawings. However, the present invention is not limited to the embodiments disclosed hereinafter, but can be implemented in diverse forms. The matters defined in the description, such as the detailed construction and elements, are nothing but specific details provided to assist those of ordinary skill in the art in a comprehensive understanding of the invention, and the present invention is only defined within the scope of the appended claims. In the entire description of the present invention, the same drawing reference numerals are used for the same elements across various figures.

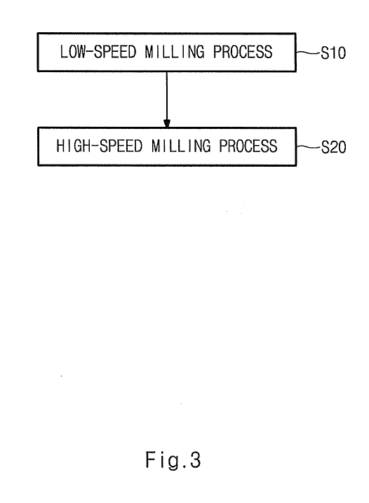

A method of fabricating nano composite powder consisting of carbon nanotubes and metal according to preferred embodiment of the present invention will be described in detail with reference to FIGS. 3 to 8.

Preferably, the method of fabricating nano composite powder consisting of the carbon nanotubes and the metal according to the present invention includes, for example as shown in FIG. 3, a low-speed milling process S10 of milling and mixing the carbon nanotubes and the metal matrix powder at low speed, and a high-speed milling process S20 of milling at high-speed the carbon nanotubes and the metal matrix powder which are homogenously mixed in the low-speed milling process S10 to homogenously disperse the carbon nanotubes in the metal matrix powder.

The method of fabricating nano composite powder consisting of the carbon nanotubes and the metal according to preferred embodiments of the present invention is described herein.

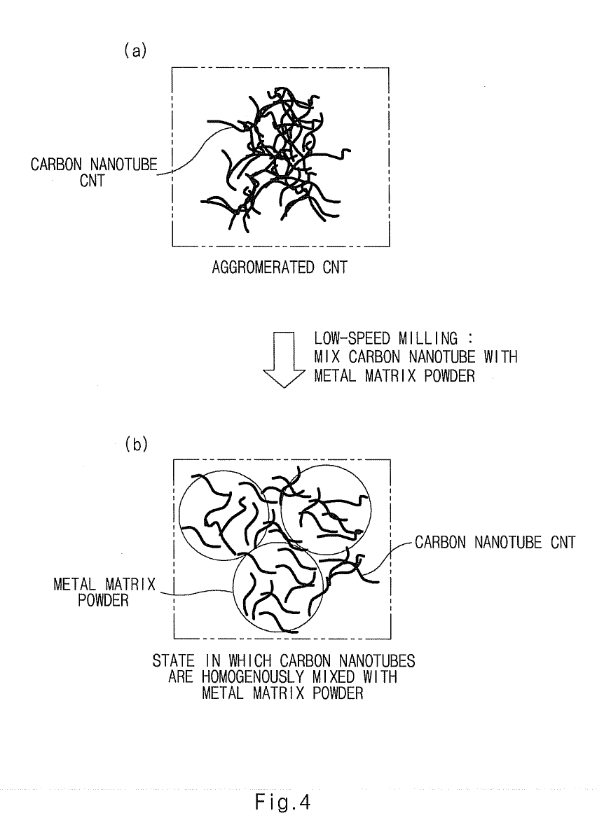

According to preferred embodiments of the present invention, in the low-speed milling process S10, the carbon nanotubes CNT and the metal matrix powder are suitably prepared and mixed, for example as shown in FIG. 4.

Preferably, the metal matrix powder includes at least one of aluminum, lithium, beryllium, magnesium, scandium, titanium, vanadium, chrome, manganese, iron, cobalt, nickel, copper, zinc, gallium, germanium, yttrium, zirconium, niobium, molybdenum, ruthenium, rhodium, palladium, silver, cadmium, indium, tin, stibium, tungsten, platinum, gold and lead.

In a further preferred embodiment, meanwhile, aluminum is preferably used and described herein by way of example in this embodiment. However, it is to be understood by one of skill in the art that any element of the above-described metal matrix powders may be suitably applied.

In a further preferred embodiments, an aggregate of 5 to 40 nm in diameter and 1 μm to 5 μm in length, preferably, 20 nm in diameter and 1 μm to 2 μm in length, is suitably prepared as the carbon nanotube CNT. Preferably, the aluminum powder having purity of 99.9% and a gain size of 2 to 30 μm is suitably prepared as the metal matrix powder of this embodiment.

Preferably, the carbon nanotube CNT is suitably dispersed in the metal matrix powder in a weight ratio of 0.1% to 50%.

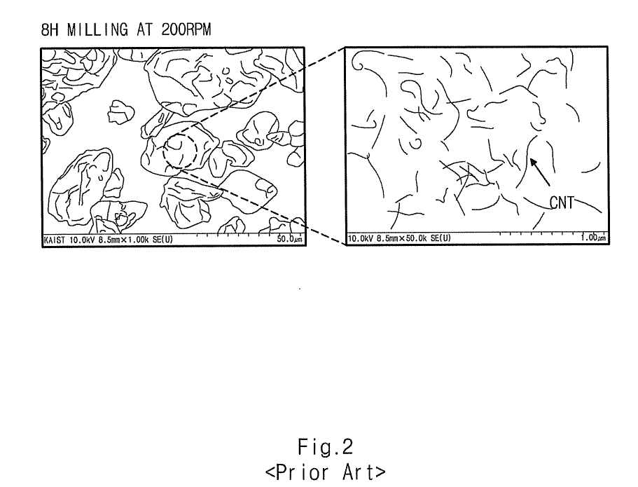

In a further preferred embodiment, when the carbon nanotubes CNT and the aluminum powder are suitably prepared, for example as shown in FIG. 2, the carbon nanotubes CNT and the aluminum powder are suitably introduced in a milling machine, and are then milled at low speed by the milling machine to homogenously mix them (see the right photograph in FIG. 2).

Preferably, the milling machine mills the carbon nanotubes CNT and the aluminum powder at a milling speed of 1 rpm to 100 rpm, preferably, 50 rpm, during 20 hours to homogenously mix them.

In a further related embodiment, the milling machine used in the low-speed milling process S10 and the high-speed milling process S20 preferably includes a planetary ball mill, a tumbler ball mill, and an attritor, and the planetary ball mill is preferable.

Preferably, the ball used in the planetary ball mill is a zirconia (ZrO₂) ball, and a jar having interval capacitance of 600 cc is preferably used.

In a further preferred embodiment, the milling machine suitably mixes the carbon nanotubes CNT and the aluminum powder by using a collision method such as ball-to ball, ball-to-chamber or ball-to attritor. Preferably, a weight ratio of the weight of the ball used in the milling machine and the weight of the carbon nanotubes CNT and the aluminum powder is suitably set to be 1:1 to 1:50, and a volume ratio of the chamber and the ball in the milling machine is set to be 1:1 to 20:1 in consideration of the collision between the ball and the chamber.

According to further preferred embodiments, in the low-speed milling process S10, the carbon nanotubes CNT and the aluminum powder are suitably milled and mixed at the low speed by using the milling machine, thereby preventing the carbon nanotube CNT from being remarkably damaged and homogenously mixing the carbon nanotubes CNT and the aluminum powder.

Preferably, when the low-speed milling process S10 is suitably completed, it is verified whether the carbon nanotubes CNT and the aluminum powder are homogenously mixed, by using a scanning electron microscope SEM.

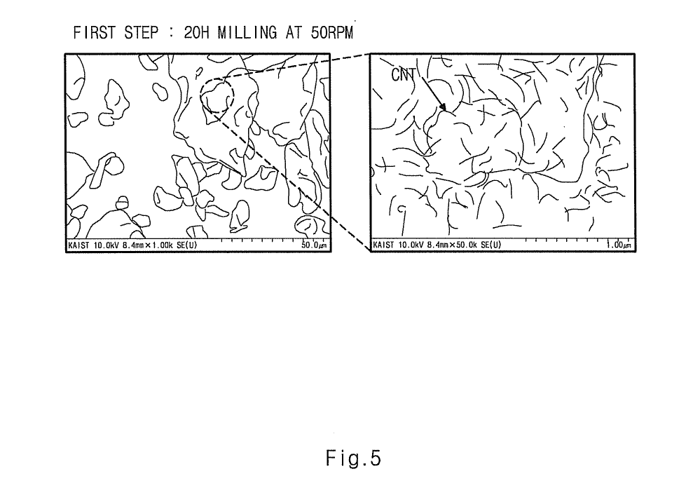

According to further preferred embodiments and as shown in FIG. 5, FIG. 5 is a microscope photograph illustrating a mixture consisting of the carbon nanotubes and the aluminum powder after the low-speed milling process.

Accordingly, the left photograph in FIG. 5 shows a mixture shape of the carbon nanotubes CNT and the aluminum powder, and the right photograph in FIG. 5 is an enlarged view of a circle indicated in the left photograph of FIG. 5.

Referring to FIG. 5, for example, it would be verified that according to certain preferred embodiments of the present invention, the carbon nanotubes are not cohered and are homogenously dispersed on the surface of the aluminum powder.

Preferably, when the low-speed milling process S10 is completed, the mixture of the carbon nanotubes CNT and the aluminum powder is milled at high speed in the high-speed milling process S20.

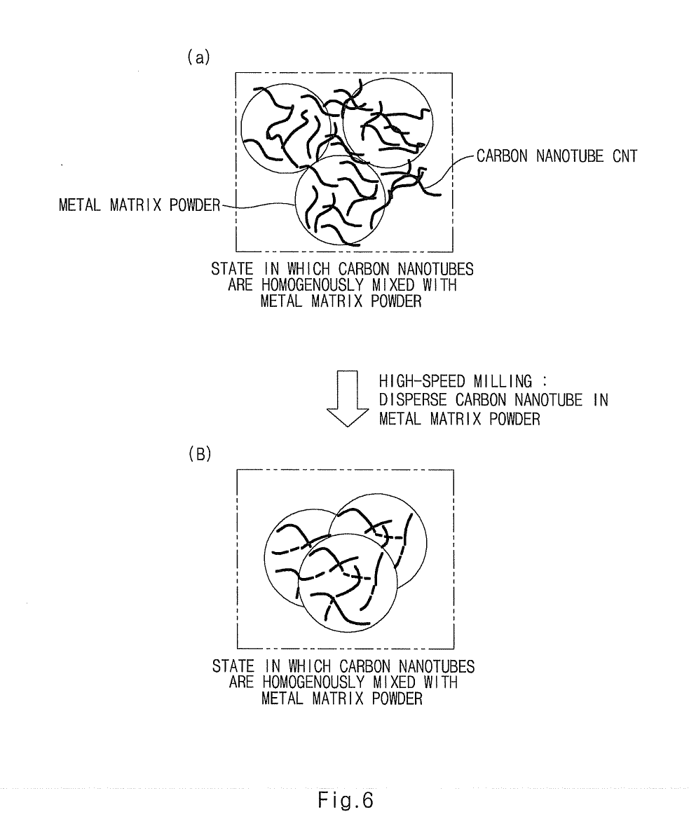

Accordingly, in the high-speed milling process S20, as shown in FIG. 6, the mixture of the carbon nanotubes CNT and the aluminum powder which is homogenously mixed in the low-speed milling process S10 is milled at a milling speed of 100 rpm to 5000 rpm, preferably, 200 rpm, by the milling machine during 1 hour.

Accordingly, in preferred exemplary embodiments of the present invention, in the high-speed milling process S20, the mixture of the carbon nanotubes CNT and the aluminum powder is milled at a high speed to homogenously disperse the carbon nanotubes CNT in the aluminum powder (see FIG. 6).

Preferably, when the high-speed milling process S20 is suitably completed, it is verified whether the carbon nanotubes CNT are homogenously dispersed in the aluminum powder, by using the scanning electron microscope SEM.

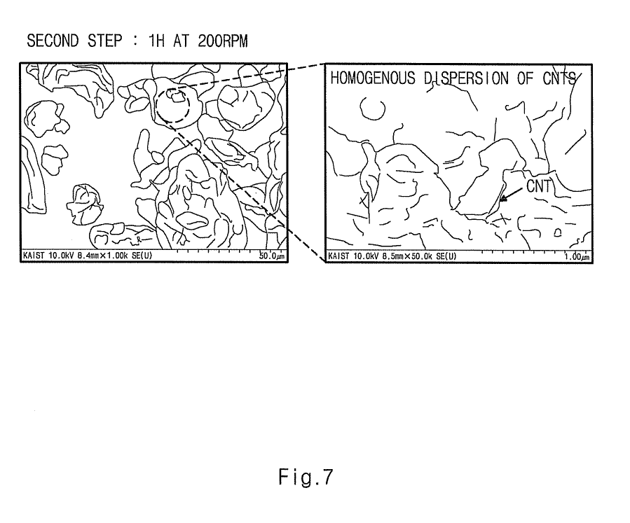

According to preferred exemplary embodiments, FIG. 7 is a photograph of a scanning electron microscope illustrating the mixture consisting of the carbon nanotubes and the metal matrix powder after the high-speed milling process S20.

Accordingly, the left photograph in FIG. 7 shows a mixture shape of the carbon nanotubes CNT and the aluminum powder, and the right photograph in FIG. 7 is an enlarged view of a circle indicated in the left photograph of FIG. 7.

For example, referring to FIG. 7, it is shown that according to preferred embodiments of the present invention, that the carbon nanotubes are not cohered and are homogenously dispersed on the surface of the aluminum powder.

Further, comparing the photograph of FIG. 2 which shows the carbon nanotube fabricated by the high energy milling process according to the related art and the right photograph of FIG. 7 which shows the carbon nanotube fabricated by the low-speed milling process S10 and the high-speed milling process S20 according to the present invention, the carbon nanotubes CNT are homogenously dispersed on the surface of the metal matrix powder.

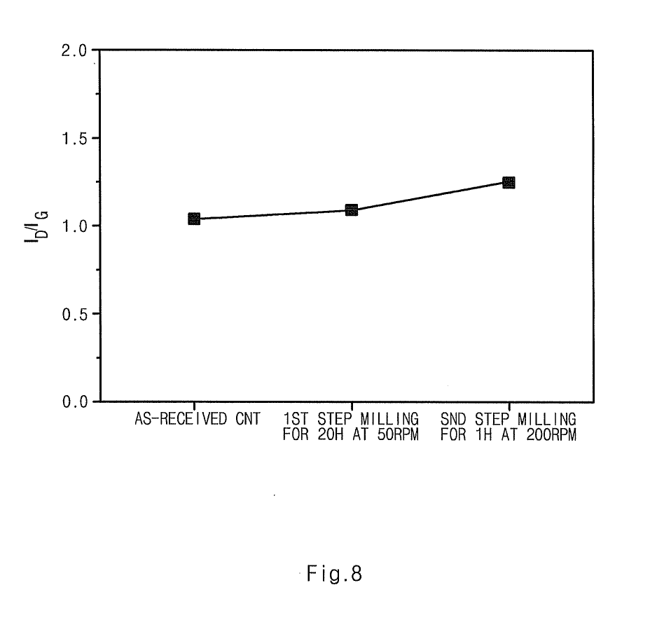

According to further preferred embodiments of the present invention and as shown in FIG. 8, FIG. 8 is a graph illustrating damage to carbon nanotubes after the low-speed milling process S10 and the high-speed milling process S20.

Accordingly, in order to verify damage to the carbon nanotube after the low-speed milling process S10 and the high-speed milling process S20, the degree of crystalline was measured by using a Raman spectroscopy. The Raman spectroscopy means that as a ratio I_{D}/I_{G} of D-peak and G-peak which are property peaks of the carbon is small, the degree of crystalline of the carbon nanotube is high.

Accordingly, as shown in measured values in FIG. 8, it is shown that the degree of crystallinity after the low-speed milling process S10 is similar to that before the process. Accordingly, as shown by the results, the carbon nanotube was not damaged.

Further, the results illustrate that the degree of crystallinity after the high-speed milling process S20 is lower that after low-speed milling process S10, but the damage of the carbon nanotube is minimized.

Consequently, comparing the measured values of the carbon nanotube CNT fabricated by the high energy milling process according to the related art shown in FIG. 2 with the measured values of the carbon nanotube CNT fabricated by the low-speed and high-speed milling processes S10 and S20, the damage of the carbon nanotube CNT according to the present invention is minimized.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A method of fabricating a nano composite powder consisting of carbon nanotubes and metal matrix powder comprising the steps of:
a low-speed milling process of milling and mixing the carbon nanotubes and the metal matrix powder; and
a high-speed milling process of milling the carbon nanotubes and the metal matrix powder which are homogenously mixed in the low-speed milling process to homogenously disperse the carbon nanotubes in the metal matrix powder.

2. The method of fabricating nano composite powder according to claim 1, wherein the low-speed milling process is performed at a milling speed of 1 rpm to 100 rpm for 20 hours.

3. The method of fabricating nano composite powder according to claim 1, wherein the high-speed milling process is performed at a milling speed of 100 rpm to 5000 rpm for 1 hour.

4. The method of fabricating nano composite powder according to claim 1, wherein in the low-speed milling process and the high-speed milling process, a milling machine selected from a planetary ball mill, a tumbler ball mill, or an attritor, and the planetary ball mill is used.

5. The method of fabricating nano composite powder according to claim 1, wherein the metal matrix powder includes at least one of selected from the group consisting of: aluminum, lithium, beryllium, magnesium, scandium, titanium, vanadium, chrome, manganese, iron, cobalt, nickel, copper, zinc, gallium, germanium, yttrium, zirconium, niobium, molybdenum, ruthenium, rhodium, palladium, silver, cadmium, indium, tin, stibium, tungsten, platinum, gold and lead.

6. The method of fabricating nano composite powder according to claim 1, wherein the carbon nanotube includes an aggregate of 5 to 40 nm in diameter and 1 μm to 5 μm in length.

7. The method of fabricating nano composite powder according to claim 1, wherein the carbon nanotube is dispersed in the metal matrix powder in a weight ratio of 0.1% to 50%.

8. The method of fabricating nano composite powder according to claim 4, wherein a weight ratio of weight of the carbon nanotubes and the aluminum powder and weight of a ball used in the milling machine and is set to be 1:1 to 1:50.

9. A method of fabricating a nano composite powder comprising:
a low-speed milling process of milling and mixing carbon nanotubes and metal matrix powder; and
a high-speed milling process.

10. The method of fabricating a nano composite powder of claim 9, wherein the high-speed milling process comprises milling the carbon nanotubes and the metal matrix powder which are homogenously mixed in the low-speed milling process to homogenously disperse the carbon nanotubes in the metal matrix powder.
